(19) United States
(12) Patent Application Publication
(10) Pub. No.: US 2019/0019150 A1
(43) Pub. Date: Jan. 17, 2019

(54) SYSTEM AND METHOD FOR MANAGING A PLURALITY OF PROPERTIES

(71) Applicant: AGIOS WORLD WIDE, INC., CORAM, NY (US)

(72) Inventor: STEVE SALIMBAS, BILLERICA, MA (US)

(73) Assignee: AGIOS WORLD WIDE, INC., CORAM, NY (US)

(21) Appl. No.: 15/649,765

(22) Filed: Jul. 14, 2017

(51) Int. Cl. G06Q 10/10; G06Q 10/06; B07C 3/00

(52) U.S. Cl. CPC G06Q 10/10; B07C 3/00; G06Q 10/067; G06Q 10/06

(57) ABSTRACT

A system for managing a plurality of properties includes a letter server, a client device, and a plurality of provider devices. The letter server is operative to store a plurality of letters for delivery to the plurality of properties. The client device is operative to electronically communicate with the letter server so as to generate the letters, and to generate a plurality of delivery orders each of which identifies at least one letter of the plurality for delivery to at least one property of the plurality. The provider devices are each operative to electronically communicate with the client device so as to receive delivery orders, and further operative to electronically communicate with the letter server so as to receive the at least one letter identified by each of the at least some delivery orders. Each letter of the plurality conforms to one or more of a plurality of regulatory requirements.

### BACKGROUND

### Technical Field

Embodiments of the invention relate generally to the management of property, and more specifically, to a system and method for managing a plurality of properties.

### Discussion of Art

When a property owner defaults on a loan secured by its property, the loan servicer will inspect and maintain the property. In particular, the servicer will assess the condition of the property and whether it is inhabited, as well as carry out routine maintenance on vacant or abandoned properties. From time to time, servicers may seek direct contact with the occupant of a house, and sometimes, must also provide written notice to the borrower associated with the corresponding property.

Typically, loan servicers or lenders will employ a third-party company to deliver the written notice, as well as to inspect and maintain the property. Third-party companies typically perform such services for multiple loan servicers. Likewise, loan servicers may utilize numerous third-party companies.

Many third-party companies use relatively low quality notice forms to initiate a contact attempt with the borrower. These notices are hung on a knob of an exterior door, or in an envelope that is secured to the exterior door of a property, and typically contain handwritten contact information. As will be appreciated, such notices are often not fully legible or contain erroneous information.

In addition, recently drafted U.S. regulations require that servicers provide written notice to the borrower that is clear, conspicuous, and includes certain content such as, inter alia, a statement encouraging the borrower to contact the servicer, the telephone number to access servicer personnel, the servicer's mailing address, and, if applicable, a statement providing a brief description of the contact purpose, e.g., call back to verify occupancy, loss mitigation options that may be available from the servicer, debt collection, etc.

As will be appreciated, a need exists for an electronically accessible property default management system that facilitates, among other things, the generation of consistent, legible, and compliant borrower notice letters.

### BRIEF DESCRIPTION

In an embodiment, a system for managing a plurality of properties is provided. The system includes a letter server, a client device, and a plurality of provider devices. The letter server is operative to store a plurality of letters for delivery to the plurality of properties. The client device is operative to electronically communicate with the letter server so as to generate the plurality of letters, and further operative to generate a plurality of delivery orders each of which identifies at least one letter of the plurality for delivery to at least one property of the plurality. The plurality of provider devices are each operative to electronically communicate with the client device so as to receive at least some delivery orders of the plurality, and further operative to electronically communicate with the letter server so as to receive the at least one letter identified by each of the at least some delivery orders. Each letter of the plurality conforms to one or more of a plurality of regulatory requirements.

In another embodiment, a method for managing a plurality of properties is provided. The method includes generating a plurality of letters for delivery to the plurality of properties, and designating each letter of the plurality as corresponding to at least one of a plurality of geographic regions. The method further includes storing the plurality of letters in a memory device of a letter server that includes at least one processor, and providing the plurality of letters to a plurality of provider devices each operated by a provider tasked with delivering at least some letters of the plurality to at least some properties of the plurality. Each letter of the plurality conforms to one or more regulatory requirements.

In yet another embodiment, a letter server for a system for managing a plurality of properties is provided. The letter server includes at least one processor, and a memory device. The memory device stores an application that adapts the at least one processor to: electronically communicate with a client device so as to generate a plurality of letters for delivery to the plurality of properties, designate each letter of the plurality as corresponding to at least one of a plurality of geographic regions, store the plurality of letters in the memory device, and provide the plurality of letters to a plurality of provider devices each operated by a provider tasked with delivering at least some of the plurality of letters to at least some properties of the plurality. Each letter of the plurality conforms to one or more regulatory requirements.

### DRAWINGS

The present invention will be better understood from reading the following description of non-limiting embodiments, with reference to the attached drawings, wherein below:

FIG. 1 is a schematic diagram a system for managing a plurality of properties, in accordance with an embodiment of the present invention;

FIG. 2 is a block diagram of a letter server of the system of FIG. 1, in accordance with an embodiment of the present invention;

FIG. 3 is a diagram of a letter generated by the system of FIG. 1, in accordance with an embodiment of the present invention;

FIG. 4 is a diagram depicting a plurality of geographical regions corresponding to the plurality of properties of the system of FIG. 1, in accordance with an embodiment of the present invention;

FIG. 5 is a diagram of a delivery order generated by the system of FIG. 1, in accordance with an embodiment of the present invention;

FIG. 6 is a photograph of a letter generated by the system of FIG. 1 at one of the properties of the plurality of FIG. 1, in accordance with an embodiment of the present invention; and

FIG. 7 is a flow chart depicting a method for managing the plurality of properties utilizing the system of FIG. 1, in accordance with an embodiment of the present invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

As used herein, the terms “substantially,” “generally,” and “about” indicate conditions within reasonably achievable manufacturing and assembly tolerances, relative to ideal desired conditions suitable for achieving the functional purpose of a component or assembly. As used herein, “electrically coupled,” “electrically connected,” and “electrical communication” mean that the referenced elements are directly or indirectly connected such that an electrical current may flow from one to the other. The connection may include a direct conductive connection, i.e., without an intervening capacitive, inductive or active element, an inductive connection, a capacitive connection, and/or any other suitable electrical connection. Intervening components may be present. The term “real-time,” as used herein, means a level of processing responsiveness that a user senses as sufficiently immediate or that enables the processor to keep up with an external process. As further used herein, the term “regulatory requirement” means a rule and/or law promulgated by a governing entity. Exemplary regulatory requirements include notice requirements as set forth by the Real Estate Settlement Procedures Act, 12 C.F.R. § 1024.39, or similar regulations specifying notice content, e.g., a statement encouraging a borrower to contact the servicer of a loan/mortgage.

Additionally, while the embodiments disclosed herein are primarily described with respect to occupancy verification and/or default, it is to be understood that embodiments of the present invention are equally applicable to other types of systems and/or methods in which delivered items are required to conform to a specified set of rules which change from geographic region to geographic region, or change based on other criteria.

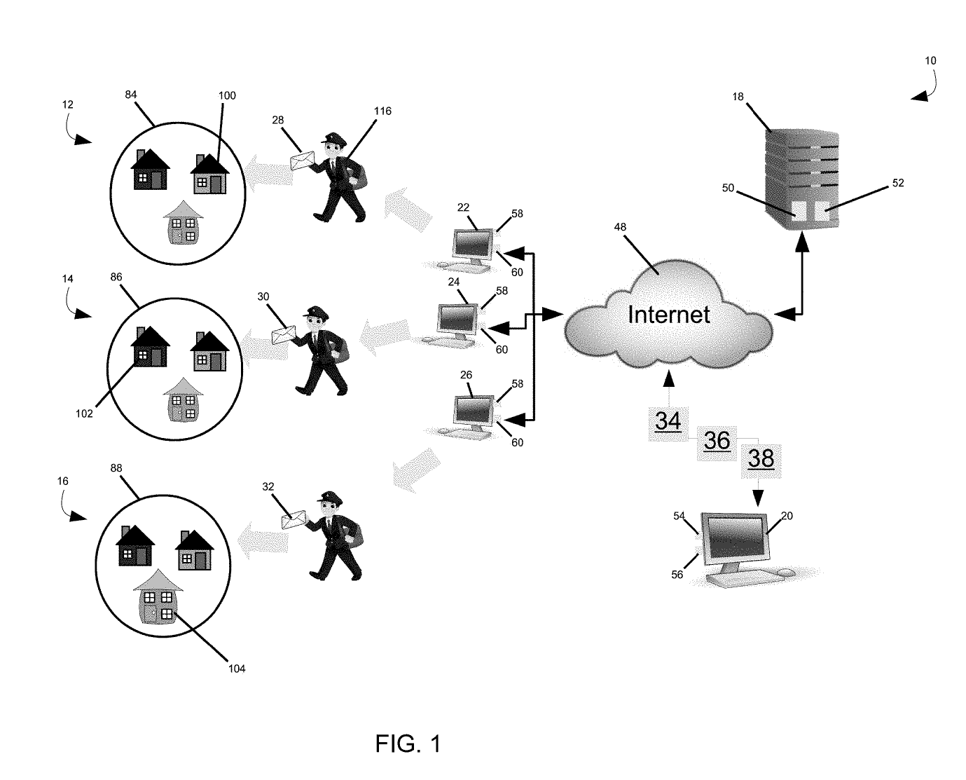

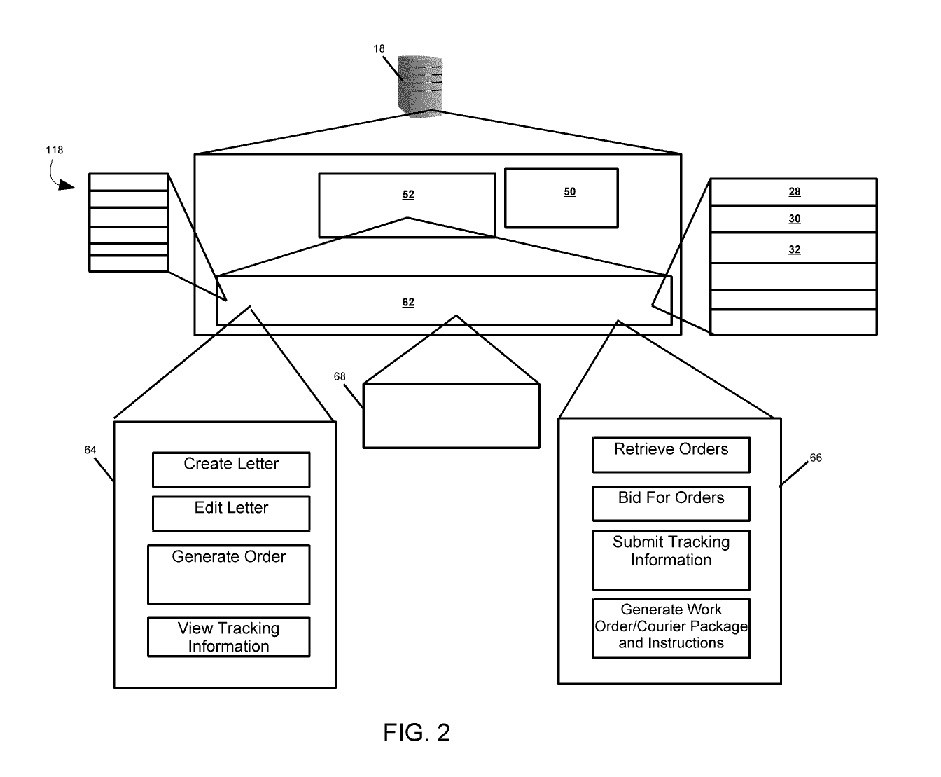

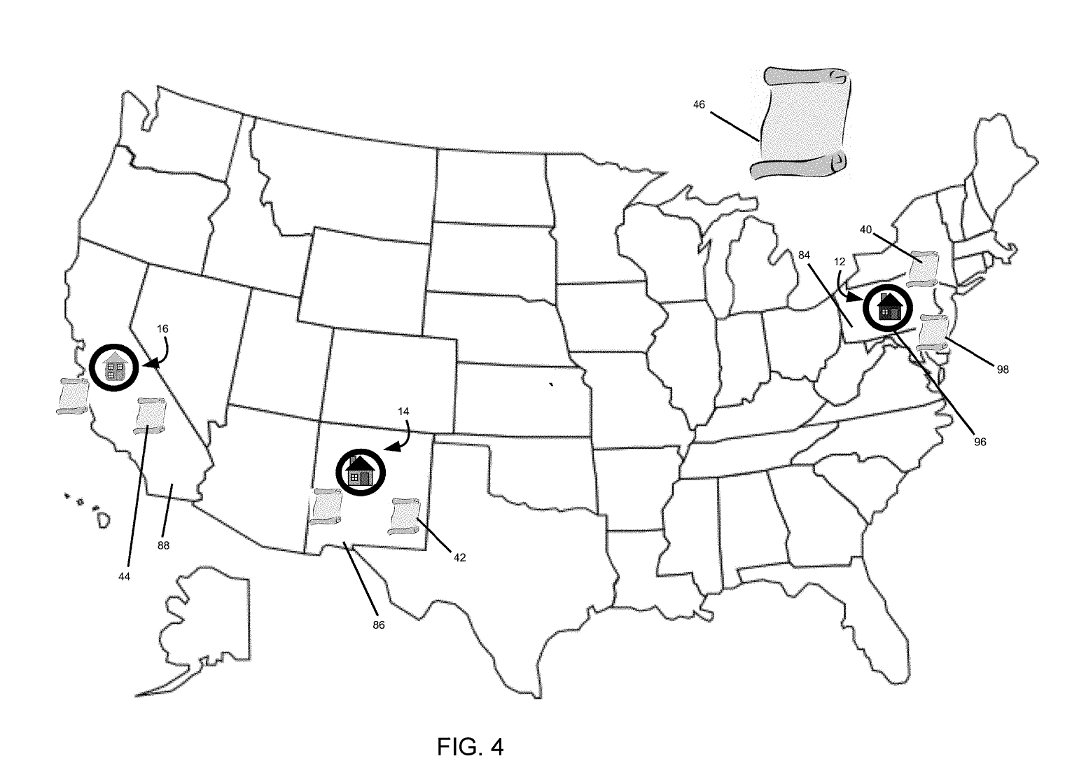

Referring now to FIGS. 1 and 2, the major components of a system 10 for managing a plurality of properties 12, 14, and 16 is shown. The system 10 includes a letter server 18, at least one client device 20, and a plurality of provider devices 22, 24, and 26. The letter server 18 is operative to store a plurality of letters 28, 30, 32 for delivery to the plurality of properties 12, 14, and 16. The client device 20 is operative to electronically communicate with the letter server 18 so as to generate the letters 28, 30, 32, and is further operative to generate a plurality of delivery orders 34, 36, and 38, each of which identifies/designates at least one letter 28, 30, 32 for delivery to at least one property of the plurality 12, 14, and 16. The provider devices 22, 24, and 26 are each operative to electronically communicate with the client device 20 so as to receive at least some of the delivery orders 34, 36, and 38, and further operative to electronically communicate with the letter server 18 so as to receive/retrieve the at least one letter 28, 30, 32 identified by each of the at least some delivery orders 34, 36, and 38. As will be appreciated, each letter 28, 30, 32 conforms to one or more of a plurality of regulatory requirements 40, 42, 44, and 46 (FIG. 4). As will be appreciated, the letter server 18, client device 20, and provider devices 22, 24, 26 may electronically communicate with each other via the Internet 48 and/or other similar network; and/or the client device 20 and provider devices 22, 24, 26 may be desktop computers, to include virtualized desktops, and/or mobile computing devices, e.g., smart phones and/or tablets.

The letter server 18 includes at least one processor 50, a memory device 52, and may be operated by an intermediate party, e.g., a service provider. The letter server 18 may be connected to the Internet 48 via one or more wired and/or wireless routers e.g., 802.11 and/or cellular. The client device 20 includes at least one processor 54, and memory device 56, and/or may be operated by a lending institution, e.g., a bank, credit union, or other entity that owns and/or services loans on one or more of the properties 12, 14, 16. Similar to the letter server 18, the client device 20 may be connected to the Internet 48 via one or more wired and/or wireless routers e.g., 802.11 and/or cellular. While FIG. 1 depicts a single client device 20, it will be understood that, in embodiments, the system 10 may include any number of client devices. The provider devices 22, 24, 26 each include at least one processor 58, memory devices 60, may be connected to the Internet 48 via wired and/or wireless connections, and may be operated by provider entities/vendors tasked/charged with delivering the letters 28, 30, 32 to the properties 12, 14, 16.

Turning to FIG. 2, a software application (“the server application”) 62 may be stored in the memory device 52 of the letter server 18 that adapts the processor 50 to perform one or more of the processes described herein. In embodiments, the server application 62 may provide for one or more application programming interfaces (“APIs”) 64 and 66 and/or a web-interface/console 68 that facilitate electronic communication between the letter server 18 and the client device 20 and/or provider devices 22, 24, 26.

Accordingly, in embodiments, an institutional user, e.g., an employee of the lending institution operating the client device 20, may use the client device 20 to logon to an institutional user account hosted by the server application 62 via a software application (“the client application”) that electronically communicates with the letter server 18/server application 62 via a client/institution API 64 and or via the web interface 68. The client application may be local to the client device 20, e.g., stored in memory device 56, and/or hosted by the letter server 18 or other suitable intermediate server. The server application 62 may then present the institutional user/client application with one or more of the following options: create/generate letter, edit existing letter, generate order, view order status.

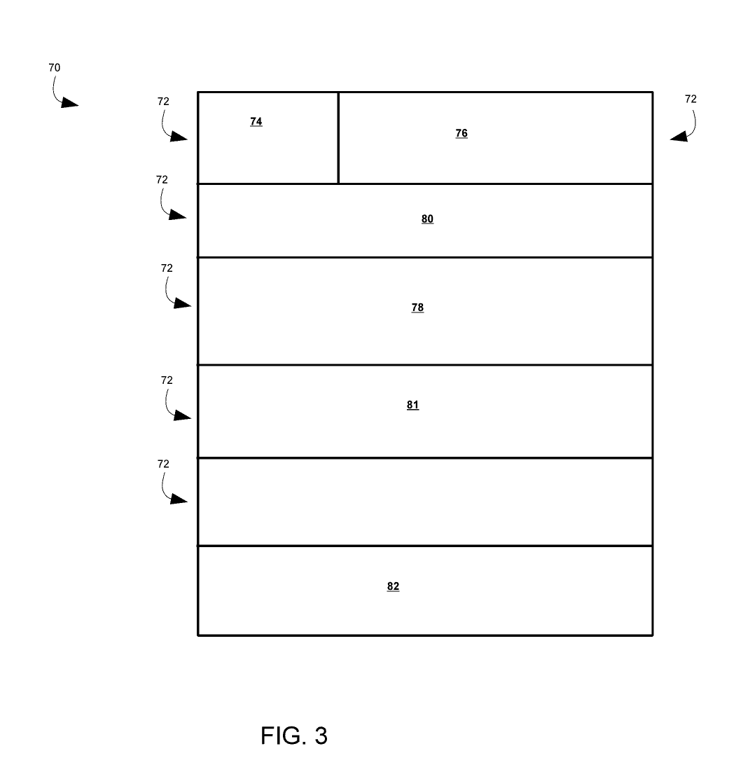

As shown in FIG. 3, the create/generate letter option provides the institutional user the ability to create/generate a new letter 70 and/or new letter components 72. As used herein, the term “letter component” refers to an item that can be included within a letter 70. For example, in certain aspects, letter components 72 may include a logo 74, a header 76, a regulator section/statement/clause 78, a return address 80, custom components 81, e.g., a graphic display of a .pdf, .jpg, .bmp, .png, .tif, .gif, etc., and/or other suitable types of components for inclusion within the letter 70 such as customized text. The server application 62 may also provide for the institutional user to specify a particular geographic tag/designation 82 that designates the letter 70 as corresponding to a particular geographic region. As will be appreciated, in embodiments, the geographic tag 82 may trigger the automatic inclusion of one or more components 72 that are required for the letter 70 to conform to one or more regulatory requirements specific to a geographic region.

For example, as shown in FIG. 4, a first group 12 of the properties may be located in a first geographic region 84, e.g., Pennsylvania, a second group 14 of the properties may be located in a second geographic region 86, e.g., New Mexico, and a third group 16 of the properties may be located within a third geographic region 88, e.g., California, wherein each of the regions 84, 86, and 88 requires different regulatory requirements 40, 42, 44, respectively. One or more regulatory requirements 46 may also be national regulatory requirements. In embodiments, regulatory requirement 40 may require any letter delivered to properties within the first geographic region 84 to include letter components 72 (FIG. 3) A, B, and C, regulatory requirement 42 may require any letter delivered to properties within the second geographic region 86 to include letter components 72 A, B, and D, and regulatory requirement 44 may require any letter delivered to properties within the third geographic region 88 to include letter components 72 D, E, and F. As will be appreciated, a geographic region 84 may include one or more sub-geographic regions 96, e.g., a county within a state, a city within a county within a state, etc, wherein each sub-region 96 may have a specific regulatory requirement 98. In other words, a geographic region may fall within another larger/encompassing geographic region.

In certain aspects of the invention, the regulatory requirements may form a hierarchy, wherein some of the regulatory requirements can override other regulatory requirements. For example, in an embodiment, there may be a national regulatory requirement 46, that may be overridden by a state level regulatory requirement 40, which in turn may be overridden by a city and/or zip code regulatory requirement 98. As used herein, the terms “override,” “overwritten,” and “overriding” with respect to one or more regulatory requirements refers to the degree of inclusion and/or exclusion of components 72 within a letter 70 corresponding to two or more regulatory requirements. Accordingly, a regulatory requirement may be: 1) an additional regulatory requirement, i.e., a higher regulatory requirement 40 that overrides a lower regulatory requirement 46 such that the higher regulatory requirement 40 supplements/adds components 72 to the components 72 within a letter 70 corresponding to the lower regulatory requirement 46; 2) a partially overriding regulatory requirement, i.e., a higher regulatory requirement 40 that overrides a lower regulatory requirement 46 such that the higher regulatory requirement 40 replaces and/or alters some of the components 72 within a letter 70 corresponding to the lower regulatory requirement 46; and/or 3) a fully overriding regulatory equipment, i.e., a higher regulatory requirement 40 that overrides a lower regulatory requirement 46 such that the higher regulatory requirement 40 fully replaces the components 72 within a letter 70 corresponding to the lower regulatory requirement 46. Additionally, the server application 62 (FIG. 2) may provide for the loan servicing institution operating the client device 20 to designate letters 70, via tag 82 (FIG. 3) as corresponding to any type of geographic region, e.g., countries, states/provinces, counties, cities, zip codes, area codes, etc. As will be understood, however, the hierarchical ordering of the regulatory requirements need not follow a geographical hierarchy.

The institutional user may then save the letter 70, and/or letter components 72, to the memory device 52 of the letter server 18 as a single document, e.g., .docx, .pdf, .txt, or as data in a database, etc. As will be understood, however, in embodiments, the components 72 may be saved individually in the memory device 52 and the letter 70 may be saved as a listing of the various components 72 that are included within the letter 70. In such embodiments, a .pdf, or other suitable format, of the letter 70 may be generated on the fly, i.e., in real-time, from the listing of components 72. As will be appreciated, storing the letter components 72 individually and generating the letters 28, 30, 32, and 70 on the fly, allows the letter components 72 to be shared across multiple letters 28, 30, 32 and 70, which in turn conserves space within the memory device 52. Further, sharing of the letter components 72 across multiple letters 28, 30, 32 and 70 improves consistency between the letters 28, 30, 32 and 70, and/or eases the management of the components 72. Further still, sharing of the letter components 72 may ease management of the letter components 72 as, in embodiments, editing a particular component, e.g., a header 76, results in the edits appearing in all letters 28, 30, 32 and 70 that reference/list the particular component 76 which are generated subsequent to the editing of the particular component 76. In other words, storing the letters 70 as a list of components 72, as opposed to a signal printable file, e.g., a .pdf, provides for the instances of the components 72 to act as master instances/templates.

Returning briefly back to FIG. 1, in embodiments, the server application 62 (FIG. 2) may further provide for the institutional user account to generate the delivery orders 34, 36, 38. For example, the institutional user account, via the client device 20, may generate a first delivery order 34 directing that a first letter 28 be delivered to a first property 100, a second delivery order 36 directing that a second letter 30 be delivered to a second property 102, and a third deliver order 38 directing that a third letter 32 be delivered to a third 104 property.

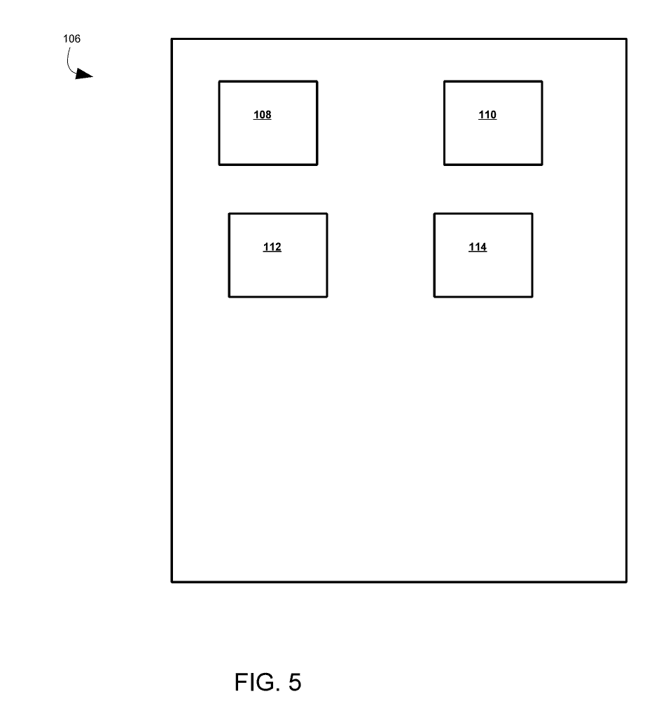

Turning to FIG. 5, a representative delivery order 106 is shown. As will be understood, the delivery order 106 may include a letter identifier 108, a delivery address 110, a letter 70 (FIG. 3) on-the-fly generation date 112, e.g., the date the letter 70 was generated, and/or a provider identifier 114. The delivery address 110 may identify one or more properties, and the letter identifier 108 identifies one or more letters stored within the letter server 18 for delivery to the one or more properties identified by the delivery address 110. The provider identifier 114 may identify which provider is to execute the delivery order 106. Thus, returning again briefly back to FIG. 1, when generated, the delivery orders 34, 36, 38 may be directly sent from the client device 20 to the provider devices 22, 24, 26, and/or or stored in the memory device 52 in the letter server 18 for subsequent retrieval by the provider devices 22, 24, 26.

Accordingly, in embodiments, a provisional user, e.g., an employee of the provider/vendor operating one of the provider devices 22, 24, and 26, may logon to a provider user account hosted by the server application 62 via a software application (“the provider application”) that electronically communicates with the letter server 18/server application 62 via a provider API 66 (FIG. 2) and/or via the web interface 68. The provider application may be local to each of the provider devices 22, 24, 26, e.g., stored in memory devices 60, and/or hosted by the letter server 18 or other suitable intermediate server. In embodiments in which the orders 34, 36, 38 are stored at the letter server 18, the server application 62 may allow a particular provider device 22, via the provider application, to retrieve orders 34 which have a delivery address 110 (FIG. 5) within the geographic region 84 of responsibility of the provider operating the particular provider device 22. In other embodiments, the particular provider device 22 may only be able to retrieve orders 34 in which the particular provider, operating the provider device 22, is identified by the provider identifier 114 (FIG. 5). The server application 62 may also allow the providers to bid for orders 34, 36, and 38 via the provider application. In embodiments, the letter server 18 may also provide an electronic alert to a provider device 22, 24, 26 that the provider's services have been requested by the loan servicing institution via the client device 20.

In embodiments, the client device 20 may send an order 34 directly to a provider device 58, and the provider device 58 may then communicate with the letter server 18 to generate a letter 28 based on data within the order 34. For Example, in embodiments, the order 34 may specify which letter components 72 are to be included in a letter 28 for delivery to a particular property 100, and the provider device 58, via the provider API 66 provided by the letter server 18, may generate the letter 28, e.g., assemble the letter components 72 specified in the order 34 into a document.

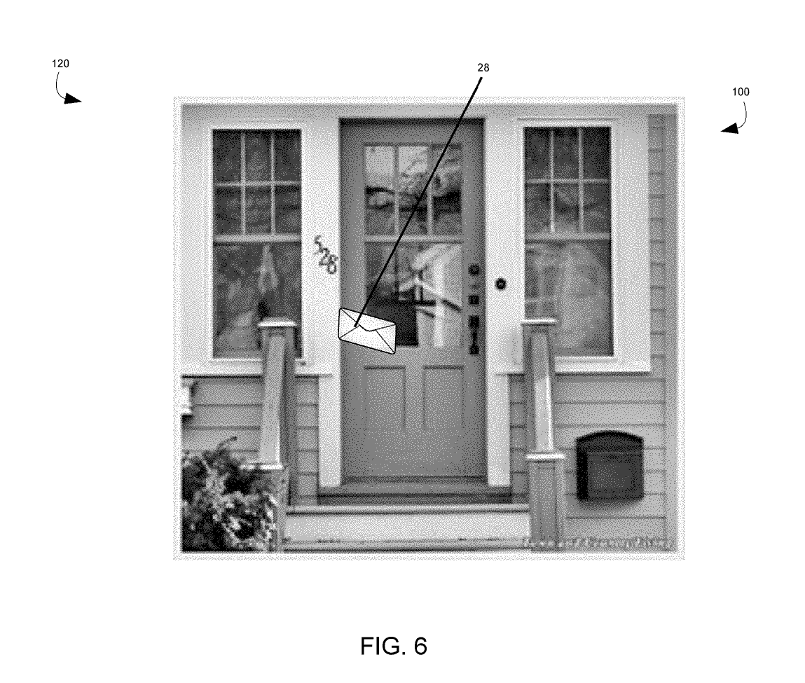

When a provider has a delivery order 34 and the corresponding letter(s) 28 identified 108 by the order 34, the provider may have a courier 116 deliver the letter 28 to the identified property 100. Upon delivery, the courier 116 and/or the provider may report back a status, e.g., delivered, not delivered, attempted delivery, etc, of the letter 28 corresponding to the order 34 to the letter server 18 via the provider application. The letter server 18 may then store the status as a part of a tracking indicator/tracking information 118 (FIG. 2). As shown in FIG. 6, in embodiments, the courier 116 may take a photograph 120 of the letter 28 at the property 100, and then transmit the photograph 120 to the letter server 18 for storage within the tracking indicator 118. In such embodiments, the letter server 18 may allow the institutional user account, via the client application on the client device 20, to view the tracking information 118 for a particular order 34. Accordingly, some embodiments of the present invention provide for tracking of the status and verification of delivery of a letter 70 to a particular address. As will be understood, the photograph 120 may include embedded information, i.e., meta data, such as location of acquisition, date/time, device id, etc, which in turn may be stored within the letter server 18 and subsequently used to track/verify delivery of one or more letters 28, 30, 32.

In certain embodiments, tracking information 118 may contain a logo specified in the institutional user account, the date a particular letter 28, 30, 32 was printed by the provider, and the property 100, 102, 104, and/or owner address information, which may be made visible/viewable on/through the exterior of a package/envelope delivered to the property 100, 102, 104, e.g., viewable through the window of a standard #10 business envelope. Additionally, when printed, the letter 28, 30, 32 may contain the unique/custom text 81 (FIG. 3), and/or a specific letter and file name, which may not be visible/viewable on/through the exterior of the package/envelope. As will be appreciated, in embodiments, the tracking information 118 may be used to generate one or more historical print logs that depict the date/time a particular letter was generated, printed, and/or delivered.

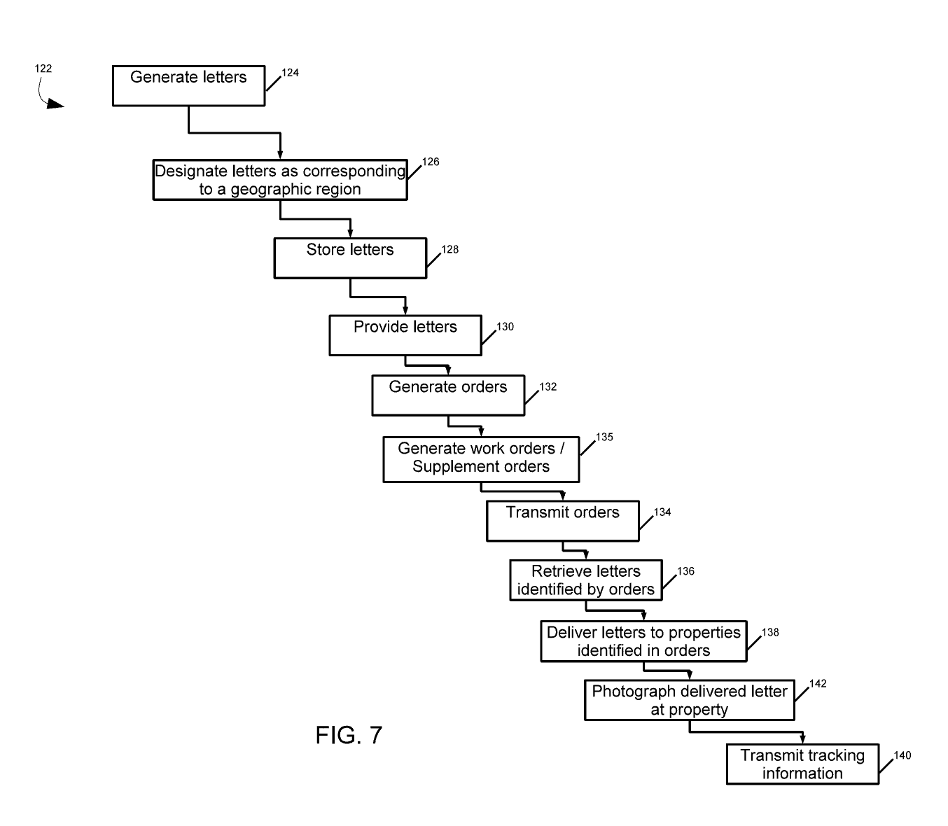

Illustrated in FIG. 7 is a method 122 for managing the plurality of properties 12, 14, 16 utilizing the system 10. The method 122 includes generating 124 the plurality of letters 28, 30, 32; designating 126 each letter 28, 30, 32 as corresponding to at least one geographic region 84, 86, 88; storing 128 the letters 28, 30, 32 in the letter server 18; and/or providing 130 the letters to the provider devices 22, 24, and 26. The method may further include generating 132 and transmitting 134 orders 34, 36, 38. As stated above, in embodiments, the orders 34, 36, 38 may be sent directly by the client device 20 to the provider devices 22, 24, 26, which in turn, may generate 135 letters 28, 30, 32 via the provider API 66 provided by the letter server 18. In embodiments where the letters 28, 30, 32 may have been generated by the client device 20 and stored on the letter server 18, generating 135 the letters 28, 30, 32 may include supplementing information/components 72 within the letters 28, 30, 32. For example, in embodiments, a default logo 74, i.e., the logo of the institution operating the client device 20, may be overridden, i.e., replaced by a different logo, i.e., the logo of an entity operating the provider device 22. In embodiments, the method 122 may further include retrieving 136 letters identified by within the transmitted 134 orders 34, 36, 38; and/or delivering 138 the letters 28, 30, 32 to the properties identified by the orders 34, 36, 38. In embodiments, the method 122 may further include transmitting 140 tracking information regarding the orders 34, 36, 38 to the letter server 18. Accordingly, in embodiments, the method 122 may further include photographing 142 a delivered letter 28, 30, 32 at the property 100, 102, 104 and transmitting 140 the photograph(s) to the letter server 18 as part of the tracking information 118.

Finally, it is also to be understood that the system 10 may include the necessary electronics, software, memory, storage, databases, firmware, logic/state machines, microprocessors, communication links, displays or other visual or audio user interfaces, printing devices, and any other input/output interfaces to perform the functions described herein and/or to achieve the results described herein, which may be accomplished in real-time. For example, as previously mentioned, the system may include at least one processor and system memory/data storage structures, which may include random access memory (RAM) and read-only memory (ROM). The at least one processor of the system may include one or more conventional microprocessors and one or more supplementary co-processors such as math co-processors or the like. The data storage structures discussed herein may include an appropriate combination of magnetic, optical and/or semiconductor memory, and may include, for example, RAM, ROM, flash drive, an optical disc such as a compact disc and/or a hard disk or drive.

Additionally, a software application that adapts the controller to perform the methods disclosed herein may be read into a main memory of the at least one processor from a computer-readable medium. The term “computer-readable medium,” as used herein, refers to any medium that provides or participates in providing instructions to the at least one processor of the system 10 (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, a RAM, a PROM, an EPROM or EEPROM (electronically erasable programmable read-only memory), a FLASH-EEPROM, any other memory chip or cartridge, or any other medium from which a computer can read.

While in embodiments, the execution of sequences of instructions in the software application causes at least one processor to perform the methods/processes described herein, hard-wired circuitry may be used in place of, or in combination with, software instructions for implementation of the methods/processes of the present invention. Therefore, embodiments of the present invention are not limited to any specific combination of hardware and/or software.

It is further to be understood that the above description is intended to be illustrative, and not restrictive. For example, the above-described embodiments (and/or aspects thereof) may be used in combination with each other. Additionally, many modifications may be made to adapt a particular situation or material to the teachings of the invention without departing from its scope.

For example, in an embodiment, a system for managing a plurality of properties is provided. The system includes a letter server, a client device, and a plurality of provider devices. The letter server is operative to store a plurality of letters for delivery to the plurality of properties. The client device is operative to electronically communicate with the letter server so as to generate the plurality of letters, and further operative to generate a plurality of delivery orders each of which identifies at least one letter of the plurality for delivery to at least one property of the plurality. The plurality of provider devices are each operative to electronically communicate with the client device so as to receive at least some delivery orders of the plurality, and further operative to electronically communicate with the letter server so as to receive the at least one letter identified by each of the at least some delivery orders. Each letter of the plurality conforms to one or more of a plurality of regulatory requirements. In certain embodiments, a first letter of the plurality conforms to a first regulatory requirement of the plurality and a second letter of the plurality conforms to a second regulatory requirement of the plurality that is different than the first regulatory requirement. In certain embodiments, the second regulatory requirement is an additional requirement with respect to the first regulatory requirement such that the second letter conforms to the first regulatory requirement in addition to the second regulatory requirement. In certain embodiments, the second regulatory requirement is a partial overriding requirement with respect to the first regulatory requirement such that the second letter conforms at least in part to the first regulatory in addition to the second regulatory requirement. In certain embodiments, the second regulatory requirement is a full overriding requirement with respect to the first regulatory requirement such that the second letter does not conform to the first regulatory requirement while conforming to the second regulatory requirement. In certain embodiments, the first regulatory requirement and the second regulatory requirement correspond to a first geographic region and a second geographic region, respectively. In certain embodiments, the second geographic region is within the first geographic region. In certain embodiments, the letter server is further operative to store one or more tracking indicators that provide a status for one or more orders of the plurality as being at least one of delivered and not delivered. In certain embodiments, each of the one or more tracking indicators includes a photograph.

Other embodiments provide for a method for managing a plurality of properties. The method includes generating a plurality of letters for delivery to the plurality of properties, and designating each letter of the plurality as corresponding to at least one of a plurality of geographic regions. The method further includes storing the plurality of letters in a memory device of a letter server that includes at least one processor, and providing the plurality of letters to a plurality of provider devices each operated by a provider tasked with delivering at least some letters of the plurality to at least some properties of the plurality. Each letter of the plurality conforms to one or more regulatory requirements. In certain embodiments, generating a plurality of letters for delivery to the plurality of properties includes generating a first letter of the plurality such that it conforms to a first regulatory requirement of the plurality, and generating a second letter of the plurality such that it conforms to a second regulatory requirement of the plurality that is different than the first regulatory requirement. In certain embodiments, the second regulatory requirement is an additional requirement with respect to the first regulatory requirement such that the second letter conforms to the first regulatory requirement in addition to the second regulatory requirement. In certain embodiments, the second regulatory requirement is a partial overriding requirement with respect to the first regulatory requirement such that the second letter conforms at least in part to the first regulatory requirement in addition to the second regulatory requirement. In certain embodiments, the second regulatory requirement is a full overriding requirement with respect to the first regulatory requirement such that the second letter does not conform to the first regulatory requirement while conforming to the second regulatory requirement. In certain embodiments, designating each letter of the plurality as corresponding to at least one of a plurality of geographic regions includes designating the first letter as corresponding to a first geographic region of the plurality, and designating the second letter as corresponding to a second geographic region of the plurality. In certain embodiments, the second geographic region is within the first geographic region. In certain embodiments, the method further includes generating a plurality of orders each of which identifies at least one letter of the plurality for delivery to at least one property of the plurality. In certain embodiments, the method further includes receiving at least some orders of the plurality at a provider device of the plurality, retrieving each of the at least one letter from the memory device of the letter server via the provider device, delivering each of the at least one letter to the at least one property, and storing in the memory device of the letter server one or more tracking indicators that provide a status for one or more orders of the plurality as being one of delivered and not delivered. In certain embodiments, the method further includes photographing each of the at least one letter at the at least one property so as to generate one or more photographs, and the one or more tracking indicators includes the one or more photographs. In certain embodiments, generating a plurality of letters for delivery to the plurality of properties includes assembling one or more letter components into a document. In certain embodiments, generating a plurality of letters for delivery to the plurality of properties includes replacing a first logo in at least one letter of the plurality with a second logo.

Yet still other embodiments provide for a letter server for a system for managing a plurality of properties. The letter server includes at least one processor, and a memory device. The memory device stores an application that adapts the at least one processor to: electronically communicate with a client device so as to generate a plurality of letters for delivery to the plurality of properties, designate each letter of the plurality as corresponding to at least one of a plurality of geographic regions, store the plurality of letters in the memory device, and provide the plurality of letters to a plurality of provider devices each operated by a provider tasked with delivering at least some of the plurality of letters to at least some properties of the plurality. Each letter of the plurality conforms to one or more regulatory requirements. In certain embodiments, a first letter of the plurality conforms to a first regulatory requirement of the plurality and a second letter of the plurality conforms to a second regulatory requirement of the plurality that is different than the first regulatory requirement. In certain embodiments, the application further adapts the at least one processor to generate a historical print log. In certain embodiments, the application further adapts the at least one processor to provide for data injection.

Accordingly, as will be appreciated, by providing for a letter server, some embodiments of the present invention provide for a centralized system for generating, storing, and retrieving letters for delivery to a multitude of properties distributed over multiple geographic regions having differing regulatory requirements. Accordingly, some embodiments of the present invention reduce the risk that a lender servicer will violate a regulatory requirement when attempting to communicate with a deficient borrower.

Further, by providing for a digitized method of generating and printing letters, some embodiments of the invention provide clear, legible typed notice letters as opposed to the current practice of leaving potentially illegible handwritten letters/door hangers and/or envelopes. Thus, some embodiments of the present invention may reduce the risk of incurring litigations for lending institution and/or hired providers and their couriers.

Further still, the manual and/or automatic inclusion of components into a letter 70, and/or the inclusion of property specific, e.g., lender information, lendee information, etc., within the components via data injection, provides for a significant improvement over generic non-tailored generic notices.

Additionally, while the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

What is claimed is:

1. A system for managing a plurality of properties comprising:
a letter server operative to store a plurality of letters for delivery to the plurality of properties;
a client device operative to electronically communicate with the letter server so as to generate the plurality of letters, and further operative to generate a plurality of delivery orders each of which identifies at least one letter of the plurality for delivery to at least one property of the plurality,
a plurality of provider devices each operative to electronically communicate with the client device so as to receive at least some delivery orders of the plurality, and further operative to electronically communicate with the letter server so as to receive the at least one letter identified by each of the at least some delivery orders; and
wherein each letter of the plurality conforms to one or more of a plurality of regulatory requirements.

2. The system of claim 1, wherein a first letter of the plurality conforms to a first regulatory requirement of the plurality and a second letter of the plurality conforms to a second regulatory requirement of the plurality that is different than the first regulatory requirement.

3. The system of claim 2, wherein the second regulatory requirement is an additional requirement with respect to the first regulatory requirement such that the second letter conforms to the first regulatory requirement in addition to the second regulatory requirement.

4. The system of claim 2, wherein the second regulatory requirement is a partial overriding requirement with respect to the first regulatory requirement such that the second letter conforms at least in part to the first regulatory in addition to the second regulatory requirement.

5. The system of claim 2, wherein the second regulatory requirement is a full overriding requirement with respect to the first regulatory requirement such that the second letter does not conform to the first regulatory requirement while conforming to the second regulatory requirement.

6. The system of claim 2, wherein the first regulatory requirement and the second regulatory requirement correspond to a first geographic region and a second geographic region, respectively.

7. The system of claim 6, wherein the second geographic region is within the first geographic region.

8. The system of claim 1, wherein the letter server is further operative to store one or more tracking indicators that provide a status for one or more orders of the plurality as being at least one of delivered and not delivered.

9. The system of claim 8, wherein each of the one or more tracking indicators includes a photograph.

10. A method for managing a plurality of properties comprising:
generating a plurality of letters for delivery to the plurality of properties;
designating each letter of the plurality as corresponding to at least one of a plurality of geographic regions;
storing the plurality of letters in a memory device of a letter server that includes at least one processor;
providing the plurality of letters to a plurality of provider devices each operated by a provider tasked with delivering at least some letters of the plurality to at least some properties of the plurality;
wherein each letter of the plurality conforms to one or more regulatory requirements.

11. The method of claim 10, wherein generating a plurality of letters for delivery to the plurality of properties comprises:
generating a first letter of the plurality such that it conforms to a first regulatory requirement of the plurality; and
generating a second letter of the plurality such that it conforms to a second regulatory requirement of the plurality that is different than the first regulatory requirement.

12. The method of claim 11, wherein the second regulatory requirement is an additional requirement with respect to the first regulatory requirement such that the second letter conforms to the first regulatory requirement in addition to the second regulatory requirement.

13. The method of claim 11, wherein the second regulatory requirement is a partial overriding requirement with respect to the first regulatory requirement such that the second letter conforms at least in part to the first regulatory requirement in addition to the second regulatory requirement.

14. The method of claim 11, wherein the second regulatory requirement is a full overriding requirement with respect to the first regulatory requirement such that the second letter does not conform to the first regulatory requirement while conforming to the second regulatory requirement.

15. The method of claim 10, wherein designating each letter of the plurality as corresponding to at least one of a plurality of geographic regions comprises:
designating the first letter as corresponding to a first geographic region of the plurality; and
designating the second letter as corresponding to a second geographic region of the plurality.

16. The method of claim 15, wherein the second geographic region is within the first geographic region.

17. The method of claim 10 further comprising:
generating a plurality of orders each of which identifies at least one letter of the plurality for delivery to at least one property of the plurality.

18. The method of claim 17 further comprising:
receiving at least some orders of the plurality at a provider device of the plurality;
retrieving each of the at least one letter from the memory device of the letter server via the provider device;
delivering each of the at least one letter to the at least one property;
storing in the memory device of the letter server one or more tracking indicators that provide a status for one or more orders of the plurality as being one of delivered and not delivered.

19. The method of claim 18 further comprising:
photographing each of the at least one letter at the at least one property so as to generate one or more photographs; and
wherein the one or more tracking indicators includes the one or more photographs.

20. The method of claim 10, wherein generating a plurality of letters for delivery to the plurality of properties comprises:
assembling one or more letter components into a document.

21. The method of claim 10, wherein generating a plurality of letters for delivery to the plurality of properties comprises:
replacing a first logo in at least one letter of the plurality with a second logo.

22. A letter server for a system for managing a plurality of properties comprising:
at least one processor;
a memory device that stores an application that adapts the at least one processor to:
electronically communicate with a client device so as to generate a plurality of letters for delivery to the plurality of properties;
designate each letter of the plurality as corresponding to at least one of a plurality of geographic regions;
store the plurality of letters in the memory device;
provide the plurality of letters to a plurality of provider devices each operated by a provider tasked with delivering at least some of the plurality of letters to at least some properties of the plurality; and
wherein each letter of the plurality conforms to one or more regulatory requirements.

23. The letter server of claim 22, wherein a first letter of the plurality conforms to a first regulatory requirement of the plurality and a second letter of the plurality conforms to a second regulatory requirement of the plurality that is different than the first regulatory requirement.

24. The letter server of claim 22, wherein the application further adapts the at least one processor to:
generate a historical print log.

25. The letter server of claim 22, wherein the application further adapts the at least one processor to:
provide for data injection.
